(19) United States
(12) Patent Application Publication
(10) Pub. No.: US 2024/0355102 A1
(43) Pub. Date: Oct. 24, 2024

(54) TRAFFIC VIOLATION PREDICTION

(71) Applicant: NEC Laboratories America, Inc., Princeton, NJ (US)

(72) Inventors: Sparsh Garg, Fremont, CA (US); Samuel Schulter, Long Island City, NY (US)

(21) Appl. No.: 18/609,097

(22) Filed: Mar. 19, 2024

Related U.S. Application Data
(60) Provisional application No. 63/460,652, filed on Apr. 20, 2023.

(51) Int. Cl. G06V 10/774; G06V 10/26; G06V 10/82; G06V 20/54; G06V 20/62

(52) U.S. Cl. CPC G06V 10/7753; G06V 10/26; G06V 10/82; G06V 20/54; G06V 20/625; G06V 2201/08

(57) ABSTRACT

Systems and methods for traffic violation prediction. The systems and methods include obtaining a plurality of bounding boxes of road scene categories from an input dataset by employing a pre-trained detection model. A plurality of pseudo-labels of road scene categories for the plurality of bounding boxes can be obtained by employing the pre-trained detection model. A labeled dataset can be obtained by filtering the input dataset for images having the plurality of pseudo-labels and the plurality of bounding boxes. A traffic violation prediction model can be trained with both unlabeled and labeled dataset including the road scene categories obtained from the pre-trained detection model to predict simultaneous traffic violations of one or more riders in a road scene.

### RELATED APPLICATION INFORMATION

This application claims priority to Provisional Application No. 63/460,652, filed on Apr. 20, 2023, incorporated herein by reference in its entirety.

### BACKGROUND

### Technical Field

The present invention relates to road traffic analysis and more particularly to systems and methods for traffic violation prediction.

### Description of the Related Art

Government entities provide road infrastructure for the public. To protect the public from the dangers of using the road infrastructure, rules are created by government entities. For example, helmets are used to protect drivers from head injury resulting from an accident. As a result, helmet rules are enacted to persuade the public to use helmets. To enforce the helmet rule, an enforcement officer provides a citation to a driver. The citation and the fine act to deter future traffic violations. However, consistent enforcement of such rules requires considerable manpower, time, and money.

### SUMMARY

According to an aspect of the present invention, a computer-implemented method for traffic violation prediction is provided. The computer-implemented method includes obtaining a plurality of bounding boxes of road scene categories from an input dataset by employing a pre-trained detection model, obtaining a plurality of pseudo-labels of road scene categories for the plurality of bounding boxes by employing the pre-trained detection model, filtering the input dataset for images having the plurality of pseudo-labels and the plurality of bounding boxes to obtain a labeled dataset, and training a traffic violation prediction model with both unlabeled and labeled dataset including the road scene categories to predict simultaneous traffic violations of one or more riders in a road scene.

According to another aspect of the present invention, a non-transitory computer-readable storage medium including a computer-readable program for traffic violation is provided. The computer-readable program when executed on a computer causes the computer to perform obtaining a plurality of bounding boxes of road scene categories from an input dataset by employing a pre-trained detection model, obtaining a plurality of pseudo-labels of road scene categories for the plurality of bounding boxes by employing the pre-trained detection model, filtering the input dataset for images having the plurality of pseudo-labels and the plurality of bounding boxes to obtain a labeled dataset, and training a traffic violation prediction model with both unlabeled and labeled dataset including the road scene categories to predict simultaneous traffic violations of one or more riders in a road scene.

According to another aspect of the present invention, a system for traffic violation prediction is provided. The system includes a memory, and one or more processors in communication with the memory configured to obtain a plurality of bounding boxes of road scene categories from an input dataset by employing a pre-trained detection model, obtain a plurality of pseudo-labels representing a combination of relevant road scene categories relative to a traffic violation of road scene categories for the plurality of bounding boxes by employing the pre-trained detection model, determine the appropriate pseudo-label for the plurality of bounding boxes from a matrix including confidence scores of a plurality of predictions representing a combination of road scene categories obtained by the pre-trained detection model by employing a softmax function, filter the input dataset for images having the plurality of pseudo-labels and the plurality of bounding boxes to obtain a labeled dataset, and train a traffic violation prediction model with both unlabeled and labeled dataset including the road scene categories to predict simultaneous traffic violations of one or more riders in a road scene.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a flow diagram illustrating a high-level overview of a method for traffic violation prediction, in accordance with an embodiment of the present invention;

FIG. 2 is a flow diagram showing a method for obtaining a plurality of bounding boxes with a plurality of pseudo-labels of road scene categories from the input dataset by employing a pre-trained detection model, in accordance with an embodiment of the present invention;

FIG. 3 is a flow diagram showing a method for training a traffic violation prediction model with a labeled dataset of the road scene categories, in accordance with an embodiment of the present invention;

FIG. 4 is a flow diagram showing a method for predicting traffic violations by employing the trained traffic violation prediction model, in accordance with an embodiment of the present invention;

FIG. 5 is a flow diagram showing a method for visualizing traffic violations into a bounded road scene, in accordance with an embodiment of the present invention;

FIG. 6 is a flow diagram showing a method for processing the bounded road scene by a traffic agency, in accordance with an embodiment of the present invention;

FIG. 7 is a block diagram showing a high-level system for traffic violation prediction as implemented in a computer system, in accordance with an embodiment of the present invention;

FIG. 8 is a block diagram illustrating a high-level system for traffic violation prediction as including input peripheral mounts, employed by a computing device implementing the method for traffic violation prediction, and a road scene, in accordance with an embodiment of the present invention; and

FIG. 9 is a block diagram showing a generalized neural network structure that can be implemented by the pre-trained detection model, the traffic violation prediction model, and the image processing model, in accordance with an embodiment of the present invention.

### DETAILED DESCRIPTION OF PREFERRED EMBODIMENTS

In accordance with embodiments of the present invention, systems and methods for traffic violation prediction are provided.

The present embodiments provide systems and computer-implemented methods for traffic violation prediction that can employ a pre-trained detection model to obtain a plurality of bounding boxes with a plurality of pseudo-labels of road scene categories in a road scene from an input dataset. The plurality of bounding boxes with the plurality of pseudo-labels can be filtered and verified by annotators to obtain a labeled dataset to train a traffic violation prediction model. After training, the traffic violation prediction model can be employed to predict traffic violations in a current road scene. The predicted traffic violations can then be visualized into a bounded road scene and processed by a traffic agency.

By employing the present embodiments, consistent enforcement of traffic rules could be attained by automatically predicting traffic violations through captured traffic images. The predicted traffic violations would be easily processed by enforcement officials as they would have the elements to notify the predicted traffic violator of their traffic violation such as the image showing the traffic violation, text of the rule violated, and instructions to respond to the violation.

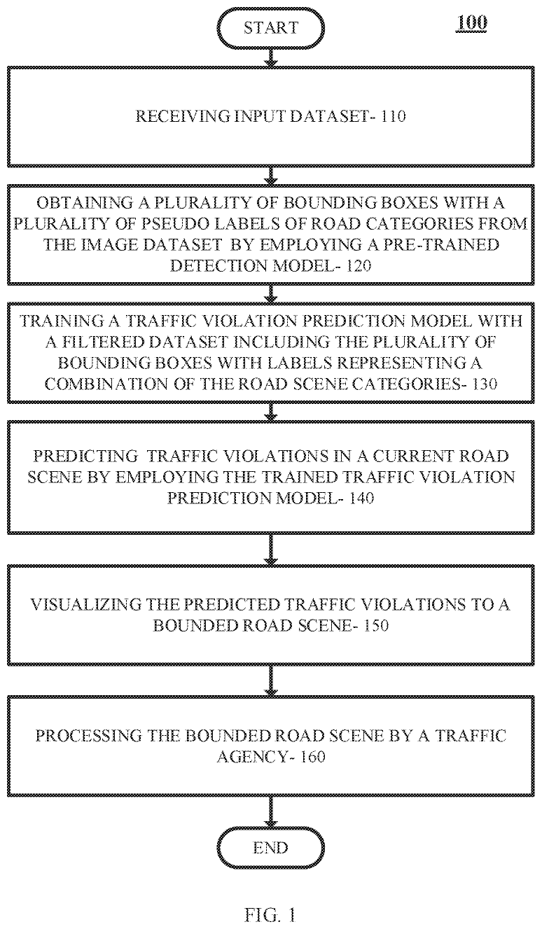

Referring now in detail to the figures in which like numerals represent the same or similar elements and initially to FIG. 1, a high-level overview of a method for traffic violation prediction is illustratively depicted in accordance with an embodiment of the present invention.

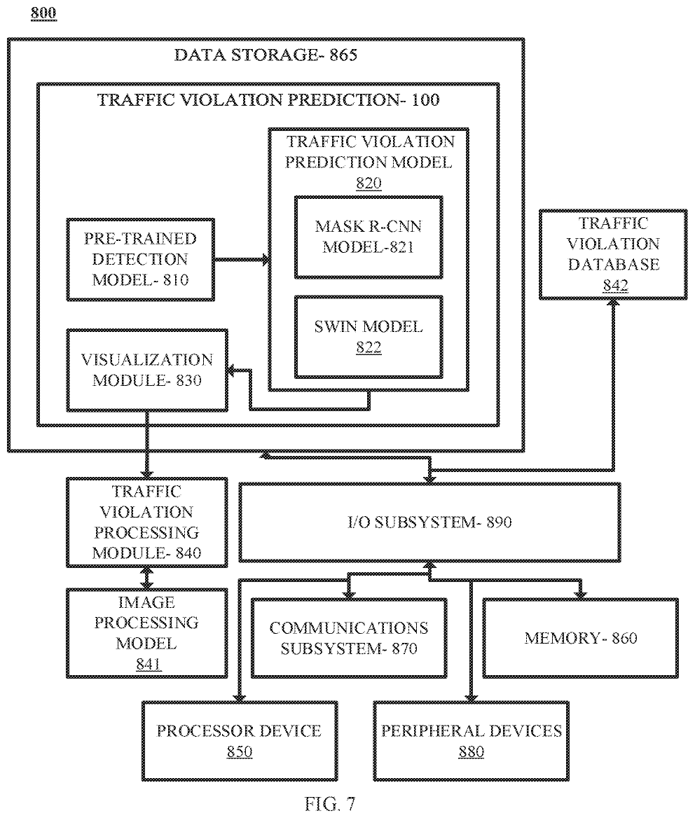

In an embodiment, a pre-trained detection model 810 (shown in FIG. 7) is employed to generate a plurality of bounding boxes of road scene categories by utilizing an input dataset. The generated bounding boxes can include a plurality of pseudo-labels that correspond to the road scene categories. The images from the input dataset containing the generated bounding boxes with pseudo-labels can be filtered and verified to obtain a labeled dataset. A traffic violation prediction model 820 (shown in FIG. 7) can then be trained by employing a vision transformer model such as a shifting windows (swin) transformer model with both unlabeled and labeled datasets. After training the traffic violation prediction model 820, a current road traffic scene can be processed to predict traffic violations and obtain a bounded road scene by employing the trained traffic violation prediction model 820. The bounded road scene can be processed to notify the predicted traffic violator of the predicted traffic violation.

In block 110, an input dataset (e.g., unlabeled) can be received for processing. The input dataset can be relevant to road traffic analysis such as IDD (India Driving Dataset), Massachusetts Institute of Technology (MIT) Traffic, Indian Traffic Sign Image Dataset, crowdsourced datasets, or government provided datasets showing road traffic. Other input datasets are contemplated.

In block 120, a plurality of bounding boxes with a plurality of pseudo-labels of road scene categories from the input dataset can be obtained by employing a pre-trained prediction model.

In block 130, a traffic violation prediction model 820 can be trained with a filtered dataset including a plurality of bounding boxes with labels representing a combination of the road scene categories.

In block 140, traffic violations in a current road scene can be predicted by employing the trained traffic violation prediction model.

In block 150, the predicted traffic violations can be visualized into a bounded road scene.

In block 160, the bounded road scene can be processed by a traffic agency.

Conventional systems fail to categorize accessories such as helmets when training a model for road traffic analysis. Unlike conventional systems, the present embodiments include categories for accessories such as helmets in training a model for road traffic analysis to predict traffic violations.

Additionally, in conventional systems, a dataset is annotated from scratch to obtain a labeled dataset to train a model. Unlike conventional systems, the present embodiments can employ a pre-trained model that generates bounding boxes of road scene categories from an unlabeled dataset which saves a significant amount of time and effort.

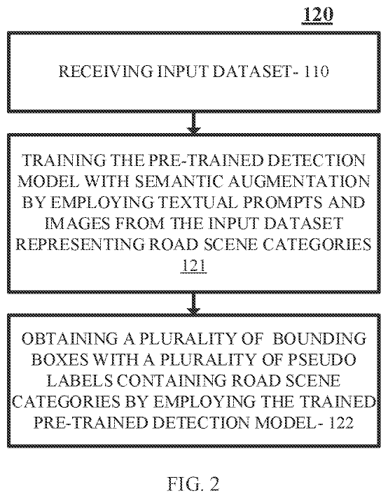

Referring now to FIG. 2, a flow diagram showing a method for obtaining a plurality of bounding boxes with a plurality of pseudo-labels of road scene categories from the input dataset by employing a pre-trained detection model, in accordance with an embodiment of the present invention.

Bounding boxes are rectangular regions employed in computer vision to identify an object in an image. Bounding boxes can be defined by the following parameters: road scene categories, top-left corner (x,y) coordinates of the box, bottom-right corner (x,y) coordinates of the box, center (x,y) coordinates of the center of the box, width of the box, height of the box, and confidence score of the likelihood that a road scene category is inside the box.

In an embodiment, the road scene categories that can be identified are vehicles, riders of vehicles, accessories of the riders. The vehicles can be further classified as a car, motorbike, truck, van, bus, etc. Other vehicle categories are contemplated. The rider of vehicles can be further classified as a driver, adult passenger, baby passenger, etc. Other rider categories are contemplated. The accessories of the riders can be further classified as a helmet, hat, shades, seatbelt, mobile phone, etc. Other accessory categories are contemplated.

In block 110, an input dataset can be received to train the pre-trained detection model 810. In an embodiment, the pre-trained detection model 810 can be employed to identify road scene categories into bounding boxes. The pre-trained detection model 810 can be trained with various open datasets that are relevant to road traffic analysis such as IDD (India Driving Dataset), Massachusetts Institute of Technology (MIT) Traffic, Indian Traffic Sign Image Dataset, crowdsourced datasets, or government provided datasets showing road traffic.

The open datasets can be unlabeled to reduce the domain gap created by having a labeled dataset that is suitable for only one domain. Thus, using an unlabeled dataset can make the pre-trained detection model 810 more robust and accurate.

In block 121, the pre-trained detection model 810 is trained with semantic augmentation by employing textual prompts and images from the input dataset representing road scene categories.

The pre-trained detection model 810 can be a universal detector model employing a neural network architecture such as an open vocab detection model contrastive language-image pretraining (CLIP), Faster region-based convolutional neural network (R-CNN), you only look once (YOLO), single shot detector (SSD), scalable and efficient object detection (EfficientDet), or Mask R-CNN.

The pre-trained detection model 810 can be trained with image-text pairs to learn visual-semantic embeddings with semantic augmentation. Semantic augmentation aims to define augmentations Ai of the features extracted from a source image where the domain shift incurrent by such augmentation Ai corresponds to a semantic difference between a generic textual prompt ps and an expected variation textual prompt pe. For example, the generic textual prompt ps can be a generic road scene such as “an image taken of a road scene.” The expected variation textual prompt pe can be a weather variation such as “an image taken of a road scene on a sunny day.” The expected variation can be related to the road scene categories such as “an image taken of a road scene on a sunny day containing two motorcycles with two riders and two helmets.” Embeddings are computed for the generic textual prompt ps and an expected variation textual prompt pe from multiple random crops extracted from an image. An augmentation Ai is searched through cosine similarity and estimated by minimizing a loss function.

In an embodiment, the textual prompts can be the road scene categories. For example, the textual prompts can be “motorcycle,” “rider,” “passenger1,” “passenger2,” “helmet,” etc. In another embodiment, the textual prompt can be a combination of the road scene categories. For example, “a motorcycle, a rider, and a helmet.”

In block 122, the plurality of bounding boxes with the plurality of pseudo-labels are obtained by employing the pre-trained detection model 810. After training, the pre-trained detection model 810 outputs the plurality of bounding boxes of the road scene categories as a matrix containing the coordinates of the bounding box, pseudo-labels, and confidence score of the likelihood of the bounding box containing the road scene categories.

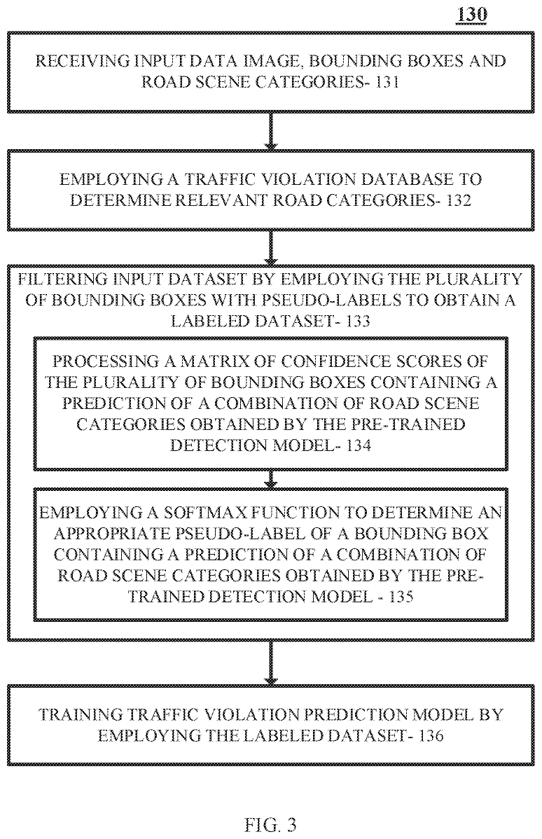

Referring now to FIG. 3, a flow diagram showing a method for training a traffic violation prediction model 820 with a labeled dataset of the road scene categories, in accordance with an embodiment of the present invention.

In block 131, the input dataset, road scene categories and the plurality of bounding boxes can be received for processing from the pre-trained detection model 810.

In block 132, a traffic violation database 842 (shown in FIG. 7), can be employed to determine the relevant road scene categories of the traffic violation. For example, the elements of a traffic violation regarding the lack of a helmet for a motorcycle rider can include a motorcycle, a rider of the motorcycle, and a lack of a helmet for the motorcycle rider.

In block 133, input data images containing relevant road scene categories of the traffic violation can be filtered from the input dataset by employing the plurality of bounding boxes and the plurality of pseudo-labels to obtain a labeled dataset. In an embodiment, the plurality of bounding boxes can have the plurality of pseudo-labels that were learned by the pre-trained detection model 810. The plurality of pseudo-labels will then be verified and renamed into road scene classes by annotators to obtain a labeled dataset. This verification process is quick and effective due to the plurality of pseudo-labels that can be pre-learned by the pre-trained detection model 810.

The plurality of pseudo-labels can correspond to the road scene categories. For example, the road scene categories can include a vehicle (e.g., car, motorbike, truck), accessory (e.g., helmet, seatbelt, mobile phone), and a rider (e.g., driver, passenger).

The plurality of pseudo-labels can also correspond to a combination of the road scene categories. For example, a pseudo-label can represent a motorbike as “MBike.” A pseudo-label combining a motorbike, a helmet and a driver where the driver wears a helmet while driving a motorbike can be obtained as “MBikeDHelmet.” A pseudo-label combining motorbike, helmet and a driver where the driver does not wear a helmet while driving a motorbike can be obtained as “MBikeDNoHelmet.” A pseudo-label combining a motorbike, a helmet and a passenger where the passenger wears a helmet while riding a motorbike can be obtained as “MBikeP1Helmet.” A pseudo-label combining a motorbike, a helmet and a passenger where the passenger wears no helmet while riding a motorbike can be obtained as “MBikeP1NoHelmet.” A pseudo-label combining a motorbike, a helmet and another passenger where the passenger wears a helmet while riding a motorbike can be obtained as “MBikeP2Helmet.” A pseudo-label combining a motorbike, a helmet and another passenger where the passenger wears no helmet while riding a motorbike can be obtained as “MBikeP2NoHelmet.” Other pseudo-labels are contemplated.

Mean average precision (mAP) can be employed to determine the accuracy of the pre-trained detection model 810. In an embodiment, a prediction is considered a true positive if it matches the ground-truth label and has an intersection over union (IOU) score of greater than or equal to 0.4 with the ground-truth bounding box.

The pseudo-labels having high thresholds of prediction accuracy can be filtered for the road scene categories to obtain a labeled dataset. For example, a bounding box with a pseudo label “MBike” with 0.4 or greater prediction score containing a motorbike.

In block 134, in an embodiment, the bounding box can have a matrix of pseudo-labels for combinations of the road scene categories. For example, one pseudo-label with confidence score of 0.5 can be “MBikeDHelmet” which corresponds to the combination of a motorbike and a driver wearing a helmet. Another pseudo-label with confidence score of 0.1 can be “MBikeDNoHelmet” which corresponds to the combination of a motorbike and a driver not wearing a helmet. Another pseudo-label with confidence score of 0.1 can be “MBikeP1NoHelmet” which corresponds to the combination of a motorbike and a passenger 1 not wearing a helmet. In this example, the pseudo-label will be “MBikeDHelmet” as it has the highest confidence score.

In block 135, in an embodiment, a softmax function can be employed to determine the pseudo-label for the bounding box having the highest confidence score. For example, a bounding box with pseudo-label of “MBike” with a confidence score of 0.95 can be obtained to represent a motorbike, and another pseudo-label of “rider” for the same bounding box with a confidence score of 0.01. In this example, the appropriate pseudo-label for the bounding box would be “MBike.”

In an embodiment, labels for the rider and for helmets can be placed in the dataset for training. In another embodiment, labels for the rider and for seatbelts can be placed in the dataset. In another embodiment, labels for the rider and for mobile phones can be placed in the dataset.

In another embodiment, a labeled dataset can be obtained by doing manual annotations. Because the bounding boxes for road scene categories can be already learned, it would be easier to annotate and filter the input dataset with the road scene categories learned. However, if a bounding box is not previously placed by the pre-trained detection model, a bounding box can be manually annotated. The manual annotations can have a similar format as the pseudo-labels. For example, a label can be “DNoHelmet” if the driver in the image is not wearing a helmet. Additionally, if the driver is wearing a helmet, the label can be “DHelmet.” The number of images to annotate can be predetermined. For example, 10, 20 or 50 images can be annotated.

In block 136, a labeled dataset can now be utilized for training the traffic violation prediction model 820 after filtering the input dataset.

In an embodiment, the traffic violation prediction model 820 can employ a Cascade Mask R-CNN as a backbone to train a vision transformer model such as a shifted window (swin) transformer model with the labeled dataset. The labeled dataset can be employed as ground truth to train the swin transformer model by employing the input dataset. The labeled dataset can include filtered images of the input dataset that contains road scene categories. The traffic violation prediction model 820 can be trained on both the labeled dataset and the unlabeled dataset utilized to train the pre-trained detection model.

In another embodiment, the backbone can be a Sparse R-CNN, adaptive training sample selection (ATSS), point set representation for object detection (RepPointsV2), etc. Other backbone architectures are contemplated. Other vision transformer models are contemplated.

After training with the labeled dataset, the traffic violation prediction model 820 can be employed to predict traffic violations in current road scenes.

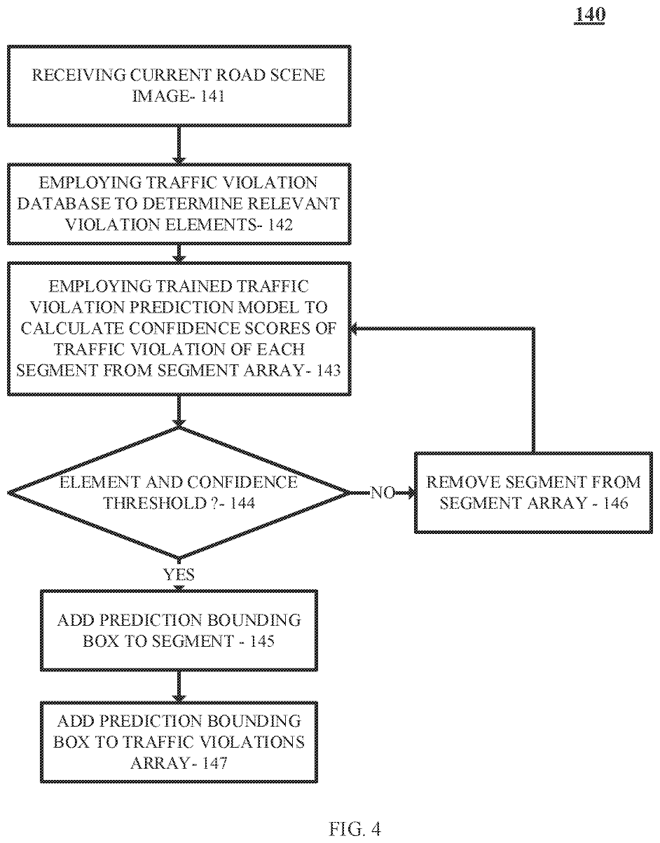

Referring now to FIG. 4, a flow diagram showing a method for predicting traffic violations by employing the trained traffic violation prediction model 820, in accordance with an embodiment of the present invention.

In an embodiment, traffic violations can be predicted by calculating the confidence score of a predicted traffic violation in the road scene and comparing the calculated confidence scores of the predicted traffic violations in the road scene to an element and confidence score threshold.

In block 141, a current road scene image is received from input peripherals for processing.

In block 142, a traffic violation database 842, can also be employed to determine elements of the traffic violation. For example, the elements of a traffic violation regarding the lack of a safety helmet for a motorcycle rider can include a motorcycle, a rider of the motorcycle, and a lack of safety helmet for the rider of the motorcycle.

In block 143, the confidence score of a traffic violation in a road scene image can be calculated. In addition to the traffic violation database 842, the trained traffic violation prediction model 820 can be employed to calculate the confidence score of the traffic violation. The trained traffic violation prediction model 820 can identify the elements of the relevant traffic violation. For example, the trained traffic violation prediction model 820 can identify from the road scene image a motorcycle, a rider and whether the rider has a helmet or not. Each element (e.g., motorcycle, rider, and whether the rider has a helmet) can have a bounding box with an associated confidence score with it. Each associated confidence score should pass the confidence score threshold.

The road scene image can be processed and prediction bounding boxes can be placed by the trained traffic violation prediction model 820 for a segment (e.g., a portion of the road scene image).

In block 144, if the segment passes both confidence score and element thresholds, a prediction bounding box will be placed on the segment in block 145. Otherwise, in block 146, the segment is removed from the segment array and the next segment can then be processed.

In an embodiment, determining whether a traffic violation is predicted or not depends on whether the segment passes an element and a confidence score threshold. The confidence score threshold can be pre-determined and compared against a confidence score obtained by employing mean average precision (mAP). The confidence score threshold is between 0 and 1. For example, the confidence score threshold can be set at 0.4 and if the confidence score calculated by the traffic violation prediction model 820 is greater than or equal to 0.4, and the element threshold is met, then the traffic violation prediction model 820 flags this as a traffic violation.

The element threshold is met when the segment contains at least two identified elements of the relevant traffic violation. For example, a prediction bounding box can be placed for a segment of the road scene image that is identified to have a rider and a motorcycle. In contrast, a prediction bounding box will not be placed if there is only one element identified in the segment of road scene image. For example, there will be no prediction bounding box for a segment containing only a person, or a parked motorcycle. As discussed above, the bounding boxes have a confidence score relative to the likelihood of the road scene categories they contain.

In an embodiment, one or more simultaneous traffic violations can be predicted using the present embodiments. For example, a road scene with three motorbikes (e.g., m1, m2, and m3) having two riders each, one driver and one passenger (e.g., p1 m1, dm1, etc.). The driver of motorbike 1 (dm1) wears a helmet while passenger 1 of motorbike 1 (p1m1) wears no helmet. The driver of motorbike 2 (dm2) wears no helmet while passenger 1 of motorbike 2 (p1m2) wears no helmet. The driver of motorbike 3 (dm3) wears a helmet while passenger 1 of motorbike 3 (p1m3) wears no helmet. The traffic violations of p1 m1, dm2, p1m2, and p1m3 can be predicted by the present embodiments.

In block 147, the prediction bounding box with the flagged traffic violation predictions can be added to a traffic violations array. In the example above, the traffic violations array can include the predicted traffic violations of p1m1, dm2, p1m2, and p1m3 where the predicted traffic violations can contain the prediction bounding box of the predicted violation.

After the segments of the current road scene image have been processed, the road scene image can then be processed for the flagged traffic violation predictions.

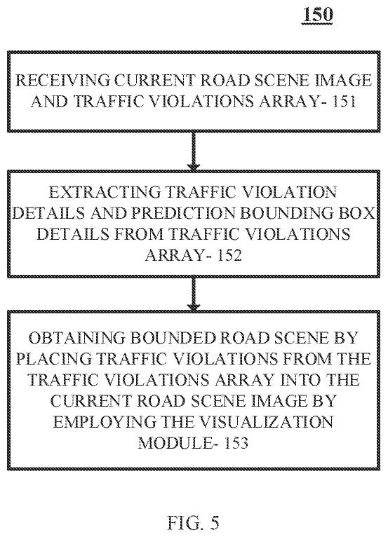

Referring now to FIG. 5, a flow diagram showing a method for visualizing traffic violations into a bounded road scene, in accordance with an embodiment of the present invention.

In block 151, the predicted traffic violations and road scene image can be received for processing.

In block 152, the predicted traffic violations from the traffic violations array can be processed by extracting their prediction bounding box details (e.g., prediction bounding box coordinates, traffic violation confidence score threshold, predicted traffic violation).

In block 153, for the predicted traffic violation, its prediction bounding box details can be processed and augmented onto the current road traffic image that captured the predicted traffic violation. For example, a rectangle with the prediction bounding box coordinates can be placed onto the image.

In an embodiment, the visualization module 830 (shown in FIG. 7) of the traffic violation prediction model 820 can process the predicted traffic violations (e.g. flagged predictions) and visualize a bounded road scene with the predicted traffic violations in a particular image format. The visualization module 830 can process the predicted traffic violation into an image format that can be accepted by a server. The image format can be JPEG, PNG, or TIFF. Other image formats are contemplated.

The bounded road scene can now be processed after adding the prediction bounding boxes.

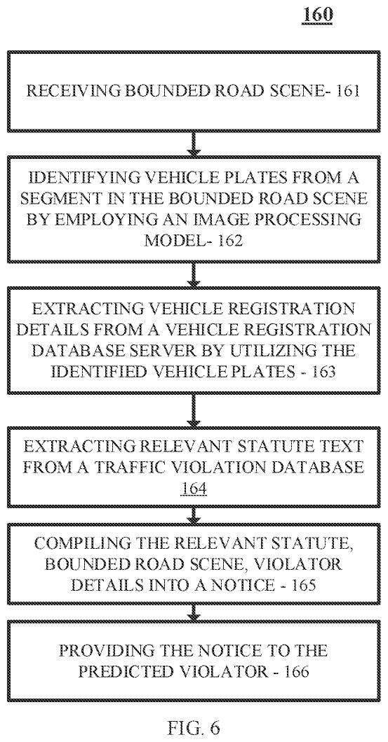

Referring now to FIG. 6, a flow diagram showing a method for processing the bounded road scene by a traffic agency, in accordance with an embodiment of the present invention.

In block 161, the bounded road scene image can be received by the traffic violation processing module 840 (shown in FIG. 7) of a traffic agency.

In an embodiment, the bounded road scene can be received and processed by the traffic violation processing module 840 employing an image processing model 841 (shown in FIG. 7) to identify relevant information regarding the traffic violator (e.g., vehicle registration details) the vehicle plates from the bounded road scene. A relevant text of the traffic violation statute can be obtained from the traffic violation database 842 (shown in FIG. 7). The statute text, the bounded road scene and instructions to respond to the traffic violation can be compiled into a notice and can be provided to the identified registered owner.

In block 162, the traffic violation processing module 840 can have an image processing model 841 that can identify the vehicle plates. In an embodiment, the image processing model can employ optical character recognition (OCR) to identify text in an image.

In block 163, after identifying the vehicle plates, the vehicle registration details can be extracted from the traffic violation database 842 employed by a traffic/vehicle registration agency. The vehicle registration details can include the registered vehicle owner, and the owner's contact information such as a home address.

In block 164, the traffic violation database 842 can be employed to help determine whether there is a violation or not. The traffic violation database 842 can include the relevant laws, statutes and other regulations. The traffic violation database 842 can also have the elements of those relevant laws, statutes and other regulations. For example, the elements in a traffic violation regarding the lack of a safety helmet for a motorcycle rider can include a motorcycle, a rider of the motorcycle, and a lack of safety helmet for the motorcycle rider.

In block 165, the traffic violation processing module 840 can compile the relevant information into a traffic violation notice that can be provided to the predicted traffic violator. The violation notice can include traffic violation details which are relevant information regarding the predicted traffic violation such as the time and date, location, relevant law violated, and instructions to respond to the violation.

In block 166, the notice can be provided to the predicted traffic violator. The notice can be provided in-person, paper mail, facsimile transmission or through electronic mail.

Referring now to FIG. 7, a block diagram showing a high-level system for traffic violation prediction as implemented in a computer system, in accordance with an embodiment of the present invention.

The computing device 800 illustratively includes the processor device 850, an input/output subsystem 890, a memory 860, a data storage device 865, and a communication subsystem 870, a traffic violation database 842, an image processing model 841, and/or other components and devices commonly found in a server or similar computing device. The computing device 800 may include other or additional components, such as those commonly found in a server computer (e.g., various input/output devices), in other embodiments. Additionally, in some embodiments, one or more of the illustrative components may be incorporated in, or otherwise form a portion of, another component. For example, the memory 860, or portions thereof, may be incorporated in the processor device 850 in some embodiments.

The traffic violation database 842 can include the relevant laws, statutes and other regulations. The traffic violation database 842 can also have the elements of those relevant laws, statutes and other regulations. The traffic violation database 842 can also have vehicle registration details.

The image processing model 841 can employ optical character recognition (OCR) to identify text in an image.

The processor device 850 may be embodied as any type of processor capable of performing the functions described herein. The processor device 850 may be embodied as a single processor, multiple processors, a Central Processing Unit(s) (CPU(s)), a Graphics Processing Unit(s) (GPU(s)), a single or multi-core processor(s), a digital signal processor(s), a microcontroller(s), or other processor(s) or processing/controlling circuit(s).

The memory 860 may be embodied as any type of volatile or non-volatile memory or data storage capable of performing the functions described herein. In operation, the memory 860 may store various data and software employed during operation of the computing device 800, such as operating systems, applications, programs, libraries, and drivers. The memory 860 is communicatively coupled to the processor device 850 via the I/O subsystem 890, which may be embodied as circuitry and/or components to facilitate input/output operations with the processor device 850, the memory 860, and other components of the computing device 800. For example, the I/O subsystem 890 may be embodied as, or otherwise include, memory controller hubs, input/output control hubs, platform controller hubs, integrated control circuitry, firmware devices, communication links (e.g., point-to-point links, bus links, wires, cables, light guides, printed circuit board traces, etc.), and/or other components and subsystems to facilitate the input/output operations. In some embodiments, the I/O subsystem 890 may form a portion of a system-on-a-chip (SOC) and be incorporated, along with the processor device 850, the memory 860, and other components of the computing device 800, on a single integrated circuit chip.

The data storage device 865 may be embodied as any type of device or devices configured for short-term or long-term storage of data such as, for example, memory devices and circuits, memory cards, hard disk drives, solid state drives, or other data storage devices. The data storage device 865 can store program code for traffic violation prediction including pre-trained detection model 810, traffic violation prediction model 820, visualization module 830, and/or the traffic violation processing module 840. Any or all of these program code blocks may be included in a given computing system. The communication subsystem 870 of the computing device 800 may be embodied as any network interface controller or other communication circuit, device, or collection thereof, capable of enabling communications between the computing device 800 and other remote devices over a network. The communication subsystem 870 may be configured to employ any one or more communication technology (e.g., wired or wireless communications) and associated protocols (e.g., Ethernet, InfiniBand®, Bluetooth®, Wi-Fi®, WiMAX, etc.) to effect such communication.

As shown, the computing device 800 may also include one or more peripheral devices 880. The peripheral devices 880 may include any number of additional input/output devices, interface devices, and/or other peripheral devices. For example, in some embodiments, the peripheral devices 880 may include a display, touch screen, graphics circuitry, keyboard, mouse, speaker system, microphone, network interface, and/or other input/output devices, interface devices, GPS, camera, and/or other peripheral devices.

Of course, the computing device 800 may also include other elements (not shown), as readily contemplated by one of skill in the art, as well as omit certain elements. For example, various other sensors, input devices, and/or output devices can be included in computing device 800, depending upon the particular implementation of the same, as readily understood by one of ordinary skill in the art. For example, various types of wireless and/or wired input and/or output devices can be employed. Moreover, additional processors, controllers, memories, and so forth, in various configurations can also be utilized. These and other variations of the computing device 800 are readily contemplated by one of ordinary skill in the art given the teachings of the present invention provided herein.

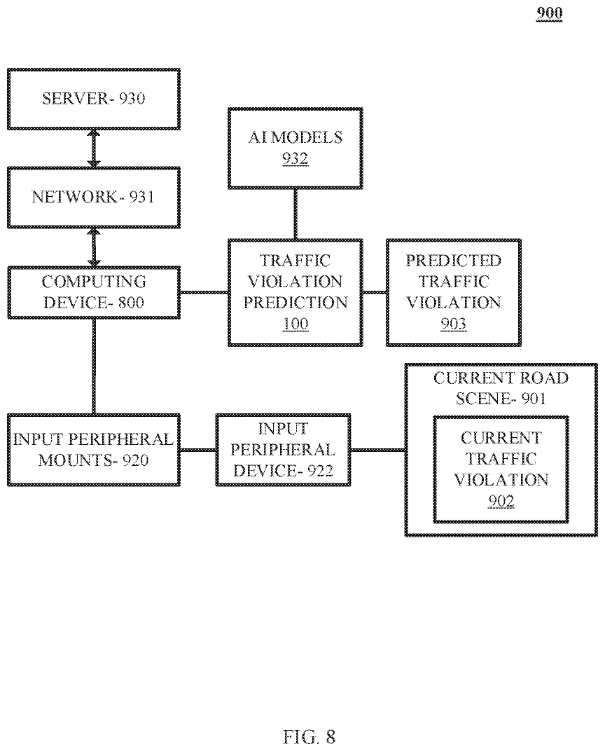

Referring now to FIG. 8, a block diagram illustrating a high-level system for traffic violation prediction 900 as including input peripheral mounts 920, employed by a computing device 800 implementing the method for traffic violation prediction 100, and a road scene 901, in accordance with an embodiment of the present invention.

FIG. 8 includes a current road scene 901, input peripheral mounts 920, computing device 800 implementing the present embodiments, a network 931 and a server 930.

The computing device 800 implementing the present embodiments can automatically predict traffic violations in seconds just by capturing image data of a current road scene 901 through input peripheral mounts 920. Upon predicting the traffic violation 903 of a current road scene 901 including a current traffic violation 902, the computing device implementing the present embodiments including artificial intelligence (AI) models 932 (e.g., pre-trained detection model 810 and traffic violation prediction model 820) can upload the output of the present embodiments (e.g. the bounded road scene) to a server 930 through the network 931. The server 930 can be a server utilized by a traffic agency. The server 930 can also be a server utilized by a private entity to monitor traffic violations in road scenes. The network can be a local area network (LAN), wide area network (WAN), a wireless LAN network, a peer-to-peer (P2P) network, a client-server network, an intranet network, and cloud computing models.

In an embodiment, the input peripheral device 922 can be mounted on a mount 920 such as traffic poles. For example, the traffic pole can be a traffic signal, traffic sign, toll booths, etc. In another embodiment, the input peripheral device 922 can be mounted on a vehicle. In another embodiment, the input peripheral device 922 can be mounted on a mobile device. In another embodiment, the input peripheral device 922 can be mounted on a building. Other mounting points are contemplated.

The current road scene 901 is the road scene perceived by the input peripheral device 922 in real-time and can include the predicted traffic violation 902.

Other practical applications of the present embodiments are contemplated.

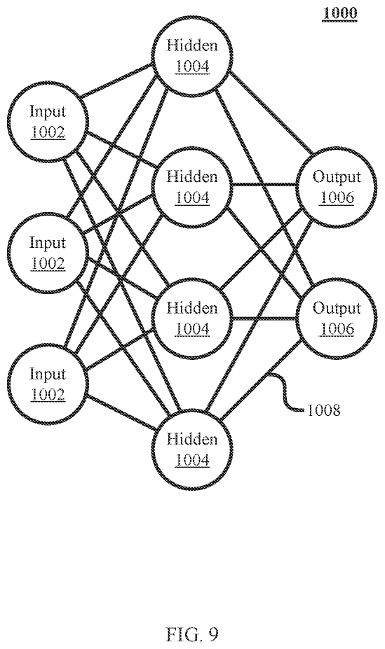

Referring now to FIG. 9, a block diagram showing a generalized neural network structure 1000 that can be implemented by the pre-trained detection model 810, the traffic violation prediction model 820, and the image processing model 841, in accordance with an embodiment of the present invention.

An artificial neural network (ANN) is an information processing system that is inspired by biological nervous systems, such as the brain. The key element of ANNs is the structure of the information processing system, which includes a large number of highly interconnected processing elements (called “neurons”) working in parallel to solve specific problems. ANNs are furthermore trained using a set of training data, with learning that involves adjustments to weights that exist between the neurons. An ANN is configured for a specific application, such as pattern recognition or data classification, through such a learning process.

The pre-trained detection model 810 and the traffic violation prediction model 820 can implement convolutional neural networks.

Convolutional neural networks (CNNs) process information using a sliding “window” across an input, with each neuron in a CNN layer having a respective “filter” that is applied at each window position. Each filter may be trained, for example, to handle a respective pattern within an input. CNNs are particularly useful in processing images, where local relationships between individual pixels may be captured by the filter as it passes through different regions of the image. The output of a neuron in a CNN layer may include a set of values, representing whether the respective filter matched each set of values in the sliding window.

Although a specific structure of an ANN is shown, having three layers and a set number of fully connected neurons, it should be understood that this is intended solely for the purpose of illustration. In practice, the present embodiments may take any appropriate form, including any number of layers and any pattern or patterns of connections therebetween.

ANNs demonstrate an ability to derive meaning from complicated or imprecise data and can be used to extract patterns and detect trends that are too complex to be detected by humans or other computer-based systems. The structure of a neural network is known generally to have input neurons 1002 that provide information to one or more “hidden” neurons 1004. Connections 1008 between the input neurons 1002 and hidden neurons 1004 are weighted, and these weighted inputs are then processed by the hidden neurons 1004 according to some function in the hidden neurons 1004. There can be any number of layers of hidden neurons 1004, and as well as neurons that perform different functions. There exist different neural network structures as well, such as a convolutional neural network, a maxout network, etc., which may vary according to the structure and function of the hidden layers, as well as the pattern of weights between the layers. The individual layers may perform particular functions, and may include convolutional layers, pooling layers, fully connected layers, softmax layers, or any other appropriate type of neural network layer. Finally, a set of output neurons 1006 accepts and processes weighted input from the last set of hidden neurons 1004.

This represents a “feed-forward” computation, where information propagates from input neurons 1002 to the output neurons 1006. Upon completion of a feed-forward computation, the output is compared to a desired output available from training data. The error relative to the training data is then processed in “backpropagation” computation, where the hidden neurons 1004 and input neurons 1002 receive information regarding the error propagating backward from the output neurons 1006. Once the backward error propagation has been completed, weight updates are performed, with the weighted connections 1008 being updated to account for the received error. It should be noted that the three modes of operation, feed forward, back propagation, and weight update, do not overlap with one another. This represents just one variety of ANN computation, and that any appropriate form of computation may be used instead.

To train an ANN, training data can be divided into a training set and a testing set. The training data includes pairs of an input (e.g., image data set) and a known output (e.g. labeled dataset). During training, the inputs of the training set are fed into the ANN using feed-forward propagation. After each input, the output of the ANN is compared to the respective known output. Discrepancies between the output of the ANN and the known output that is associated with that particular input are used to generate an error value, which may be backpropagated through the ANN, after which the weight values of the ANN may be updated. This process continues until the pairs in the training set are exhausted.

After the training has been completed, the ANN may be tested against the testing set (e.g., current road traffic scene 901), to ensure that the training has not resulted in overfitting. If the ANN can generalize to new inputs, beyond those which it was already trained on, then it is ready for use. If the ANN does not accurately reproduce the known outputs of the testing set, then additional training data may be needed, or hyperparameters of the ANN may need to be adjusted.

ANNs may be implemented in software, hardware, or a combination of the two. For example, each weight 1008 may be characterized as a weight value that is stored in a computer memory, and the activation function of each neuron may be implemented by a computer processor. The weight value may store any appropriate data value, such as a real number, a binary value, or a value selected from a fixed number of possibilities, that is multiplied against the relevant neuron outputs.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs).

These and other variations of a hardware processor subsystem are also contemplated in accordance with embodiments of the present invention.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A computer-implemented method for traffic violation prediction, by employing a processor device, comprising:
obtaining a plurality of bounding boxes of road scene categories from an input dataset by employing a pre-trained detection model;
obtaining a plurality of pseudo-labels of road scene categories for the plurality of bounding boxes by employing the pre-trained detection model;
filtering the input dataset for images having the plurality of pseudo-labels and the plurality of bounding boxes to obtain a labeled dataset; and
training a traffic violation prediction model with both unlabeled and labeled dataset including the road scene categories to predict simultaneous traffic violations of one or more riders in a road scene.

2. The computer-implemented method of claim 1, wherein the pre-trained detection model is a Universal Detector model.

3. The computer-implemented method of claim 1, wherein the traffic violation prediction model employs a Mask region-based convolutional neural network (R-CNN) as a backbone to train a shifted window (swin) transformer model.

4. The computer-implemented method of claim 1, wherein the labeled dataset includes filtered images containing road scene categories as ground truth employed to train the traffic violation prediction model.

5. The computer-implemented method of claim 1, further includes predicting traffic violations by comparing a confidence score of the predicted traffic violation against a confidence score threshold and an element threshold.

6. The computer-implemented method of claim 1, wherein the pseudo-labels generated by the pre-trained detection model include a combination of relevant road scene categories relative to a traffic violation.

7. The computer-implemented method of claim 1, wherein filtering further includes processing a matrix of confidence scores of the plurality of bounding boxes containing a prediction of a combination of road scene categories obtained by the pre-trained detection model.

8. The computer-implemented method of claim 7, wherein filtering further includes employing a softmax function to determine an appropriate pseudo-label of a bounding box from the plurality of bounding boxes containing a prediction of a combination of road scene categories obtained by the pre-trained detection model.

9. The computer-implemented method of claim 1, further includes employing the predicted simultaneous traffic violations in a bounded road scene to be processed by a traffic agency to provide one or more notices of the predicted traffic violation to the predicted traffic violator.

10. A non-transitory computer-readable storage medium comprising a computer-readable program for traffic violation prediction wherein the computer-readable program when executed on a computer causes the computer to perform:
obtaining a plurality of bounding boxes of road scene categories from an input dataset by employing a pre-trained detection model;
obtaining a plurality of pseudo-labels of road scene categories for the plurality of bounding boxes by employing the pre-trained detection model;
filtering the input dataset for images having the plurality of pseudo-labels and the plurality of bounding boxes to obtain a labeled dataset; and
training a traffic violation prediction model with both unlabeled and labeled dataset including the road scene categories to predict simultaneous traffic violations of one or more riders in a road scene.

11. The non-transitory computer-readable storage medium of claim 10, wherein the pre-trained detection model is a Universal Detector model.

12. The non-transitory computer-readable storage medium of claim 10, wherein the traffic violation prediction model employs a Mask region-based convolutional neural network (R-CNN) as a backbone to train a shifted window (swin) transformer model.

13. The non-transitory computer-readable storage medium of claim 10, wherein the labeled dataset includes filtered images containing road scene categories as ground truth employed to train the traffic violation prediction model.

14. The non-transitory computer-readable storage medium of claim 10, further includes predicting traffic violations by comparing a confidence score of the predicted traffic violation against a confidence score threshold and an element threshold.

15. The non-transitory computer-readable storage medium of claim 10, wherein the pseudo-labels generated by the pre-trained detection model include a combination of relevant road scene categories relative to a traffic violation.

16. The non-transitory computer-readable storage medium of claim 10, wherein filtering further includes processing a matrix of confidence scores of the plurality of bounding boxes containing a prediction of a combination of road scene categories obtained by the pre-trained detection model.

17. The non-transitory computer-readable storage medium of claim 16, wherein filtering further includes employing a softmax function to determine an appropriate pseudo-label of a bounding box from the plurality of bounding boxes containing a prediction of a combination of road scene categories obtained by the pre-trained detection model.

18. The non-transitory computer-readable storage medium of claim 10, further includes employing the predicted simultaneous traffic violations in a bounded road scene to be processed by a traffic agency to provide one or more notices of the predicted traffic violation to the predicted traffic violator.

19. A system for traffic violation prediction, the system comprising:
a memory; and
one or more processors in communication with the memory configured to:
obtain a plurality of bounding boxes of road scene categories from an input dataset by employing a pre-trained detection model;
obtain a plurality of pseudo-labels representing a combination of relevant road scene categories relative to a traffic violation of road scene categories for the plurality of bounding boxes by employing the pre-trained detection model;
determine an appropriate pseudo-label for a bounding box from the plurality of bounding boxes from a matrix including confidence scores of a plurality of predictions representing a combination of road scene categories obtained by the pre-trained detection model by employing a softmax function;
filter the input dataset for images having the plurality of pseudo-labels and the plurality of bounding boxes to obtain a labeled dataset; and
train a traffic violation prediction model with both unlabeled and labeled dataset including the road scene categories to predict simultaneous traffic violations of one or more riders in a road scene.

20. The system for traffic violation prediction of claim 19, further includes to employ the predicted simultaneous traffic violations in a bounded road scene to be processed by a traffic agency to provide one or more notices of the predicted traffic violation to the predicted traffic violator.
